(19) United States
(12) Patent Application Publication
(10) Pub. No.: US 2014/0174093 A1
(43) Pub. Date: Jun. 26, 2014

(54) GAS TURBINE ENGINE LUBE OIL SYSTEM

(71) Applicant: SOLAR TURBINES INCORPORATED, San Diego, CA (US)

(72) Inventors: Alin Cezar Postescu, San Diego, CA (US); Behnam Heydari, San Diego, CA (US)

(73) Assignee: SOLAR TURBINES INCORPORATED, San Diego, CA (US)

(21) Appl. No.: 13/722,936

(22) Filed: Dec. 20, 2012

(51) Int. Cl. F02C 7/06

(52) U.S. Cl. CPC F02C 7/06
USPC 60/772; 60/39.08

(57) ABSTRACT

A gas turbine engine lube oil system (740) includes a first passage (750) and a second passage (760). The first passage (750) includes a first elongated compartment (751) with a closed end (752) and a first open end (753) distal to the closed end (752). The first passage (750) also includes a plurality of bearing return line connection points. The second passage (760) includes a second elongated compartment (761) with a suction end (762) and a second open end (763) distal to the suction end (762). The first open end (753) is in flow communication with the second open end (763).

### TECHNICAL FIELD

The present disclosure generally pertains to gas turbine engines, and is more particularly directed toward a lube oil system.

Gas turbine engines include compressor, combustor, and turbine sections. The compressor and turbine are connected to a shaft extending through the gas turbine engine. The shaft is supported by multiple bearings within the gas turbine engine. The bearings are lubricated and cooled by oil. The oil may become aerated during operation of the gas turbine engine.

U.S. Pat. No. 4,191,356 to R. Ashmun discloses an engine mounting base. The engine mounting base has a first hollow portion containing fluid at generally atmospheric pressure, and a second hollow frame portion containing fluid at a preselected pressure above atmospheric pressure. Preferably, the mounting base includes a plurality of elongate tubes having closed ends and connected together at various elevations to provide a plurality of chambers useful for fluid distribution and collection purposes.

The present disclosure is directed toward overcoming one or more of the problems discovered by the inventors.

### SUMMARY OF THE DISCLOSURE

A gas turbine engine lube oil system is disclosed. The lube oil system includes a first passage and a second passage. The first passage includes a first elongated compartment with a closed end and a first open end distal to the closed end. The first passage also includes a plurality of bearing return line connection points. The second passage includes a second elongated compartment with a suction end and a second open end distal to the suction end. The first open end is in flow communication with the second open end.

A method for deaerating lube oil in a gas turbine engine lube oil system is also disclosed. The method includes returning lube oil from gas turbine engine bearing assemblies to a first passage of an elongated passage lube oil tank. The method also includes flowing the lube oil from bearing return line connection points in the first passage through the first passage to a first flow transfer connection point and away from a closed end of the first passage. The first flow transfer connection point is distal to the closed end of the first passage. The method also includes transferring the lube oil from the from the first flow transfer connection point to a second flow transfer connection point of a second passage of the elongated passage lube oil tank by a flow connection means. The second passage is in flow isolation from the first passage except for the flow connection means. The method further includes flowing the lube oil from the second flow connection point to a suction end of the second passage, the second flow connection point being distal to the suction end.

### BRIEF DESCRIPTION OF THE DRAWINGS

FIG. 1 is a schematic illustration of an exemplary gas turbine engine.

FIG. 2 is a perspective view of the gas turbine engine of FIG. 1 with a gas turbine engine base frame.

FIG. 3 is a perspective view of the gas turbine engine base frame of FIG. 2.

FIG. 4 is a schematic drawing of the lube oil tank in the base frame of FIG. 3.

FIG. 5 is a flowchart of a method for deaerating lube oil in a gas turbine engine lube oil system.

### DETAILED DESCRIPTION

The systems and methods disclosed herein include a gas turbine engine lube oil system with a lube oil tank. In embodiments, the lube oil tank includes a first passage and a second passage adjacent and parallel to the first passage. The bearing drain lines of the lube oil system return the used lube oil to the first passage. The lube oil travels at a relatively constant flow down the first passage, across to the second passage at one end of the second passage and back to the opposite or suction end of the second passage. The elongated and split paths of the first passage and the second passage may prevent lube oil from short circuiting the flow path of the lube oil tank. This may prevent the oil from entering the suction line to the pump prior to achieving the predetermined retention time within the pump, which may deaerate the oil.

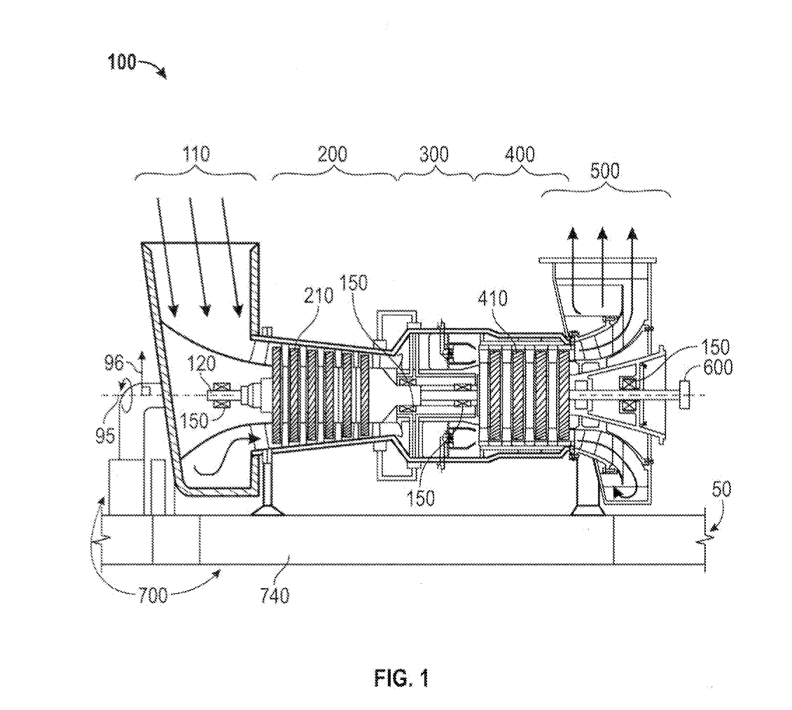

FIG. 1 is a schematic illustration of an exemplary gas turbine engine. Some of the surfaces have been left out or exaggerated (here and in other figures) for clarity and ease of explanation. Also, the disclosure may reference a forward and an aft direction. Generally, all references to “forward” and “aft” are associated with the flow direction of primary air (i.e., air used in the combustion process), unless specified otherwise. For example, forward is “upstream” relative to primary air flow, and aft is “downstream” relative to primary air flow.

In addition, the disclosure may generally reference a center axis 95 of rotation of the gas turbine engine, which may be generally defined by the longitudinal axis of its shaft 120. The center axis 95 may be common to or shared with various other engine concentric components. All references to radial, axial, and circumferential directions and measures refer to center axis 95, unless specified otherwise, and terms such as “inner” and “outer” generally indicate a lesser or greater radial distance from, wherein a radial 96 may be in any direction perpendicular and radiating outward from center axis 95.

A gas turbine engine 100 includes an inlet 110, a shaft 120, a gas producer or “compressor” 200, a combustor 300, a turbine 400, an exhaust 500, and a power output coupling 600. The gas turbine engine 100 may have a single shaft or a dual shaft configuration. The gas turbine engine 100 may be supported by or connected to a gas turbine engine base frame (“base frame”) 50. The lube oil system, generally indicated as 700, along with other ancillary gas turbine engine systems may also be connected to the base frame 50 which forms the base of the system.

The compressor 200 includes a compressor rotor assembly 210 mechanically coupled to shaft 120. The turbine 400 includes a turbine rotor assembly 410 mechanically coupled to the shaft 120. Shaft 120 is supported by a plurality of bearing assemblies 150. The embodiment in FIG. 1 includes four bearing assemblies 150. Another embodiment includes five bearing assemblies 150. Lube oil is provided to each bearing assembly 150 by lube oil system 700. While lube oil system 700 is shown adjacent to inlet 110 in FIG. 1, some components may be located on or attached to other parts of base frame 50 and within gas turbine engine 100. Lube oil system 700 includes lube oil tank 740. In the embodiment shown, lube oil tank 740 is located under gas turbine engine 100 within base frame 50.

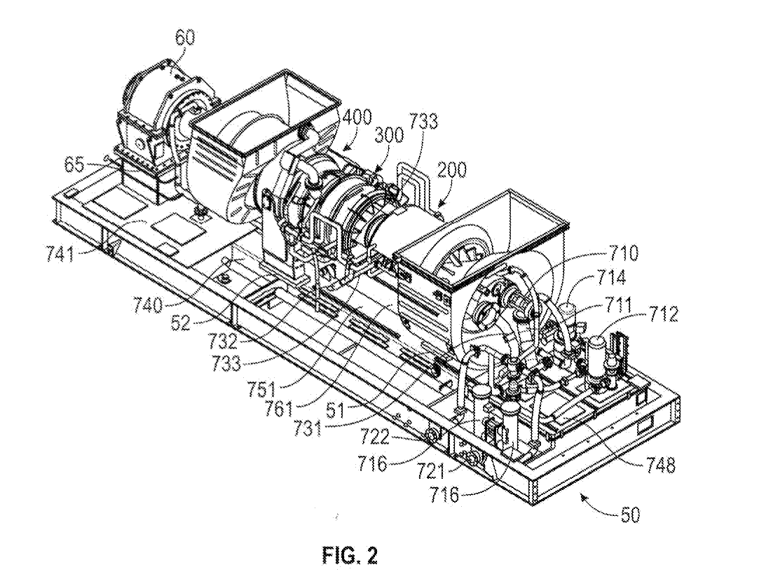

FIG. 2 is a perspective view of the gas turbine engine 100 of FIG. 1 with a gas turbine engine base frame 50 and lube oil system 700. The gas turbine engine base frame 50 may include a generator (not shown), a reduction gearbox 60, and a gearbox pedestal 65. Lube oil system 700 includes a main driven pump 710, driven pump suction line 711, an AC pre/post pump 712, a DC backup pump 714, lube oil filters 716, multiple bearing drain lines, and lube oil tank 740.

Main driven pump 710 may be attached to gas turbine engine 100 near inlet 110. Main driven pump 710 generally provides the pressure needed in the lube oil system 700 to supply lube oil to bearing assemblies 150 and other systems that utilize lube oil. Main driven pump 710 may be shaft driven or AC/DC driven. Main driven pump 710 is connected to driven pump suction line 711. Driven pump suction line 711 is connected to lube oil tank 740.

AC pre/post pump 712 may be located near main driven pump 710. AC pre/post pump 712 may assist in providing the system pressure during start up and shut down of gas turbine engine 100 or at any other time that main driven pump 710 is not operating at the minimum operating speed. DC backup pump 714 may be located adjacent to AC pre/post pump 712. DC backup pump 714 may supply system pressure in the event main driven pump 710 loses power or fails.

Lube oil filters 716 may also be located near main driven pump 710. Lube oil from main driven pump 710 may pass through lube oil filters 716 prior to being directed to bearing assemblies 150 and any other systems that use lube oil.

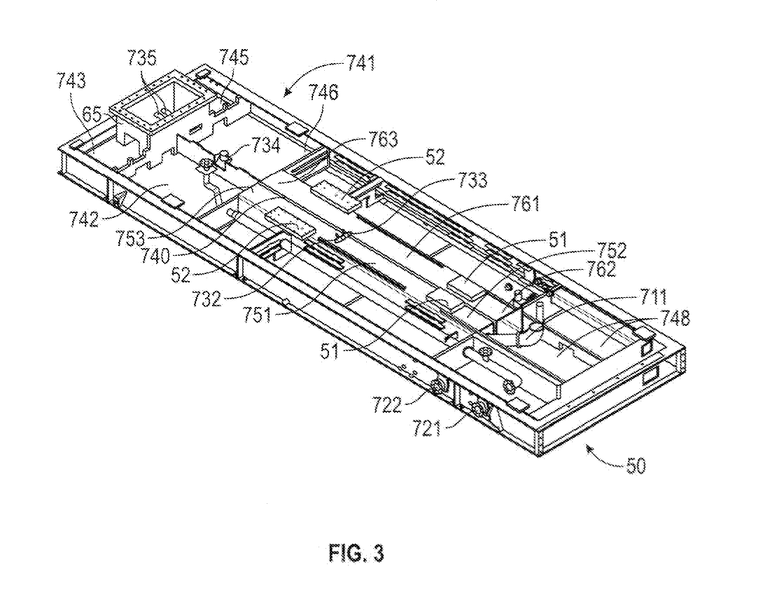

FIG. 3 is a perspective view of the gas turbine engine base frame 50 of FIG. 2. Referring to FIGS. 2 and 3, bearing drain lines return the lube oil from the bearing assemblies 150 to the lube oil tank 740. In the embodiment shown in FIGS. 2 and 3, the bearing drain lines include a first bearing drain 731, a second bearing drain 732, a third bearing drain 733, and a fourth bearing drain 734. Each bearing drain line may return lube oil from one or more bearing assemblies 150 to lube oil tank 740. The lube oil system 700 may also include generator drains 735 and a reduction gearbox drain (not shown) that return lube oil from the generator and reduction gearbox 60 to the lube oil tank 740. In one embodiment, first bearing drain 731 also includes lube oil returning to the lube oil tank 740 from the auxiliary gearbox (not shown).

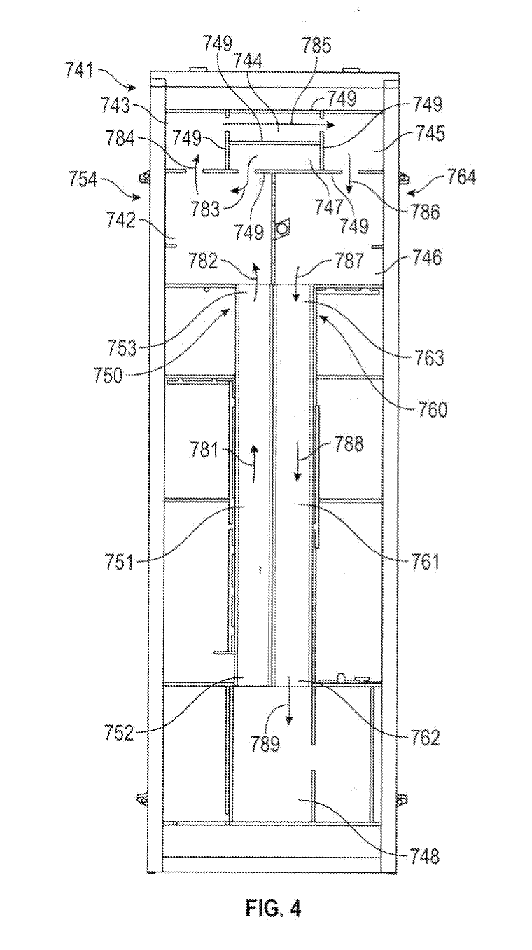

FIG. 4 is a schematic drawing of the lube oil tank 740 in the base frame 50 of FIG. 3. Referring now to FIGS. 3 and 4 lube oil tank 740 is an elongated or split passage tank. In the embodiment depicted here, the elongated passage tank includes first passage or section 750 and second passage or section 760. First passage 750 includes first elongated compartment 751. First elongated compartment 751 includes a closed end 752 and a first open end 753 opposite closed end 752. First elongated passage 751 may be parallel to axis 95 or shaft 120 of gas turbine engine 100. First passage 750 may also include first compartment 754. First compartment 754 may be connected to first elongated compartment 751 at first open end 753. First compartment 754 may be subdivided into several smaller compartments. In the embodiment shown in FIGS. 3 and 4, first compartment 754 includes first side compartment 742, first corner compartment 743, and reduction gearbox drain compartment 747; first corner compartment 743 is located distal to the connection to first open end 753.

Second passage 760 includes second elongated compartment 761. Second elongated compartment 761 includes a suction end 762 and a second open end 763 opposite suction end 762. Second elongated passage 761 may be parallel to axis 95 or shaft 120 of gas turbine engine 100. Second passage 760 may also include second compartment 764. Second compartment 764 may be connected to second elongated compartment 761 at second open end 763. Second compartment 764 may also be subdivided into several smaller compartments. In other embodiments multiple passages in series may be used.

In the embodiment shown in FIGS. 3 and 4, Second passage 760 is adjacent to first passage 750, suction end 762 is adjacent closed end 752, and second open end 763 is adjacent first open end 753. Second compartment 764 includes second side compartment 746 and second corner compartment 745. Second corner compartment 745 is located distal to the connection to second open end 763.

In some embodiments, second passage 760 includes suction compartment 748, which is adjacent to suction end 762. Driven pump suction line 711 may connect to suction end 762 or to suction compartment 748.

Second passage 760 is isolated from first passage 750 except for a single point of flow communication. In one embodiment, first open end 753 is in flow communication with second open end 763. In some embodiment, first passage 750 includes a first connection point located distal to the closed end 752 and second passage 760 includes a second connection point located distal to the suction end 762. First connection point and second connection point may be connected by a compartment, tube, pipe or port. In one embodiment, the first connection point is first open end 753 and the second connection point is second open end 763. In another embodiment, the first connection point is at an end of first compartment 754 at a location distal to the connection between first compartment 754 and first elongated compartment 751, and second connection point is at an end of second compartment 764 at a location distal to the connection between second compartment 764 and second elongated compartment 761. In the embodiment shown in FIG. 4, first connection point is first corner compartment 743 and second corner compartment 745 is second connection point; first corner compartment 743 and second corner compartment 745 are connected by flow transfer compartment 744.

Referring to FIG. 3, first elongated compartment 751 and second elongated compartment 761 may be rectangular tubes. Other cross-sections for the tubes may also be used. The lengths of the tubes may be determined by the available space within base frame 50 and the volume of lube oil needed for the lube oil system 700. In one embodiment, first elongated compartment 751 and second elongated compartment 761 are each longer than the combined axial length of the compressor 200, the combustor 300, and the turbine 400. In another embodiment, first passage 750 and second passage 760 are each longer than the axial length of the gas turbine engine 100. All or a portion of first passage 750 and second passage 760 may be welded together and fixed within base frame 50. Particularly, first elongated compartment 751 may be welded to second elongated compartment 761.

A portion of lube oil tank 740 may be formed from a sub-divided containment area (“area”) 741. Area 741 includes a lube oil path to direct lube oil through area 741 from an inlet of area 741 to an outlet of area 741 without short circuiting the path.

In the embodiment shown in FIGS. 3 and 4, area 741 is divided into compartments by bulkheads 749. The inlet of area 741 is connected to first open end 753 and the outlet of area 741 is connected to second open end 763. Area 741 includes portions of first passage 750 and portions of second passage 760. More specifically, area 741 includes first side compartment 742, first corner compartment 743, flow transfer compartment 744, second corner compartment 745, second side compartment 746, and reduction gearbox drain compartment 747. Bulkheads 749 prevent flow communication between compartments for first passage 750 and second passage 760 except for at the designated flow transfer connection point. Each bulkhead 749 may include slots near the top of the bulkhead. The slots may permit air communication between compartments.

Bearing return lines, generator drains 735, and the reduction gearbox drain may have connection points at first passage 750 and at the connection between first passage 750 and second passage 760, but not at second passage 760. In the embodiment shown in FIG. 3, first bearing drain 731 connects to closed end 752; second bearing drain 732 and third bearing drain 733 connect to first elongated compartment 751 near the midpoint of first elongated compartment 751; fourth bearing drain 734 connects to first side compartment 742 adjacent the bulkhead between first side compartment 742 and second side compartment 746; the reduction gearbox drain connects to the reduction gearbox drain compartment 747.

A lube oil vent may connect to any of the compartments of lube oil tank 740. The lube oil vent may allow air to vent to atmosphere. A lube oil vent may be a hole, a slot or a pipe that permits air to pass between lube oil tank 740 and the atmosphere. In one embodiment, lube oil vent is a ten inch pipe connected to the top of second corner compartment 745.

Lube oil system 700 may also include a heater (not shown) and a cooler (not shown). The cooler may be located off of base frame 50. Referring to FIGS. 2 and 3, base frame 50 may include cooler suction port 721 and cooler return port 722 for connecting the cooler to driven pump suction line 711.

First elongated compartment 751 and second elongated compartment 761 may be structured to support gas turbine engine 100. In the embodiments shown in FIGS. 2 and 3, a forward gas turbine engine mount 51 and an aft gas turbine engine mount 52 are attached to first elongated compartment 751, and a forward gas turbine engine mount 51 and an aft gas turbine engine mount 52 are attached to second elongated compartment 761.

One or more of the above components (or their subcomponents) may be made from carbon steel, aluminum, stainless steel and/or durable, high temperature materials known as “superalloys”. A superalloy, or high-performance alloy, is an alloy that exhibits excellent mechanical strength and creep resistance at high temperatures, good surface stability, and corrosion and oxidation resistance. Superalloys may include materials such as HASTELLOY, INCONEL, WASPALOY, RENE alloys, HAYNES alloys, INCOLOY, MP98T, TMS alloys, and CMSX single crystal alloys.

Gas turbine engines may be suited for any number of industrial applications such as various aspects of the oil and gas industry (including transmission, gathering, storage, withdrawal, and lifting of oil and natural gas), the power generation industry, cogeneration, aerospace, and other transportation industries.

During operation of the gas turbine engine 100, rotating assemblies such as shaft 120 coupled with compressor rotor assembly 210 and turbine rotor assembly 410 are generally supported by bearing assemblies 150. Bearing assemblies 150 and other gas turbine engine components may use lube oil during operation to reduce friction, reduce component wear, remove particle contaminants, and to remove heat. Lube oil may be supplied by a lube oil system such as lube oil system 700.

During operation of a lube oil system in a gas turbine engine, lube oil may become aerated with entrained air or foam. Aerated oil may cause oxidative or thermal degradation. Aerated oil may also reduce thermal conductivity of the oil and impair heat transfer. Aerated oil may also affect oil compressibility which may reduce the effectiveness of the oil pump, may reduce oil density, and may cause cavitation.

Lube oil system 700 with lube oil tank 740 may reduce or remove the aeration of the lube oil. The down and back oil path from first passage 750 to second passage 760 may provide the retention time needed for the air to migrate out of the lube oil. The separate elongated compartments of first passage 750 and second passage 760 and the bulkhead divisions between first passage 750 and second passage 760 may prevent lube oil from short circuiting the flow path of lube oil tank 740 and may ensure that the lube oil in lube oil tank 740 is retained within lube oil tank 740 for a predetermined retention time. In one embodiment, lube oil is retained in lube oil tank 740 for an average of three minutes. Actual retention times for each bearing drain may vary based on each bearing drain's connection point with first passage 750.

Lube oil system 700 with a first elongated compartment 751 and a second elongated compartment 761 may reduce the number of pipes used and the length of pipes used in a lube oil system. Reducing the number of pipes and the length of the pipes may decrease the overall cost of the lube oil system by reducing the complexity, the number of welds needed, and the amount of piping used during assembly. The use of first elongated compartment 751 and second elongated compartment 761 may also minimize the number of bulkheads 749 needed within the lube oil tank 740 and may balance the volume of the lube oil tank 740, leaving more space for other components and packaging on base frame 50.

Lube oil system with first passage 750 and second passage 760 may provide for an optimal oil flow with little to no interference between the bearing drain lines and the driven pump suction line 711.

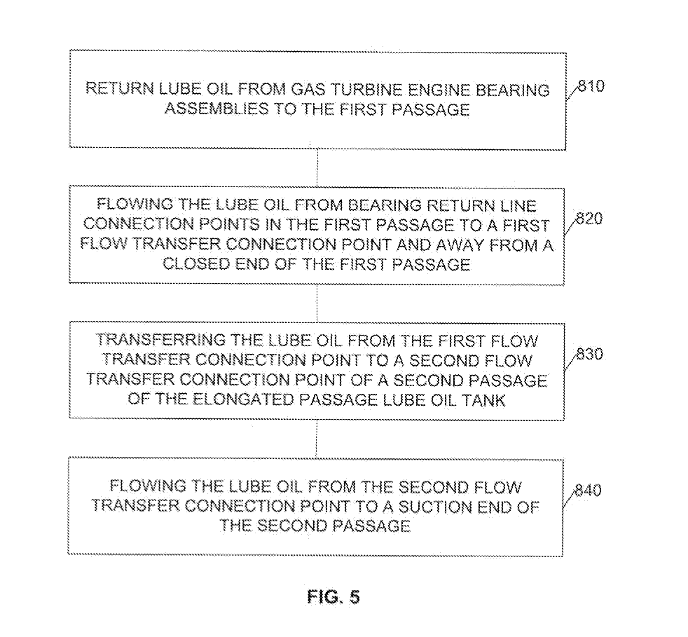

FIG. 5 is a flowchart of a method for deaerating lube oil in a gas turbine engine lube oil system 700. The method includes returning lube oil from gas turbine engine bearing assemblies 150 to the first passage 750 of an elongated or split passage lube oil tank 740 at step 810. Lube oil is generally returned to the first passage 750 in one of the bearing drain lines. Lube oil may also be returned in a generator drain 735 or in a reduction gearbox drain line. Step 810 is followed by flowing the lube oil from bearing return line connection points in the first passage 750 to a first flow transfer connection point and away from a closed end 752 of the first passage 750 at step 820. The first flow transfer connection point of first passage 750 is distal to closed end 752. In the embodiment shown in FIG. 4, lube oil is directed along path 781 from closed end 752 to first open end 753; lube oil is then directed from first open end 753 into first side compartment 742 along path 782; some lube oil is also directed along path 783 from reduction gearbox drain compartment 747 into first side compartment 742; lube oil is then directed along path 784 from first side compartment 742 into first corner compartment 743.

Step 820 is followed by transferring the lube oil from the first transfer connection point to the second flow transfer connection point of the second passage 760 at step 830. The lube oil flow may be transferred by a compartment, tube, pipe or port. In the embodiment shown in FIG. 4, first corner compartment 743 is the first flow transfer connection point and second corner compartment 745 is the second flow transfer connection point; the lube oil is directed a long path 785 from first corner compartment 743 through flow transfer compartment 744 and into second corner compartment 745.

Step 830 is followed by flowing the lube oil from the second flow transfer connection point to the suction end 762 of the second passage 760 at step 840. In the embodiment shown in FIG. 4, the lube oil is directed along path 786 from second corner compartment 745 to second side compartment 746; the lube oil is then directed into second open end 763 from second side compartment 746 along path 787; the lube oil is then directed back along path 788 across second elongated compartment 761 to suction end 762.

The flow through first elongated compartment 751 along path 781 may be directed in a first flow direction parallel to axis 95 or shaft 120 of gas turbine engine 100. The flow through second elongated compartment 761 along path 788 may be directed in a second flow direction parallel to axis 95 or shaft 120 of gas turbine engine 100 and in a direction opposite the direction of the first flow direction.

The method for deaerating lube oil may also include pumping the lube oil from a suction end 762 of the second passage 760 or from a suction compartment 748 adjacent to second passage 760 to the gas turbine engine bearing assemblies 150. In the embodiment shown in FIG. 4, the lube oil is directed through suction end 762 and into suction compartment 748 along path 789; the lube oil is then drawn from the suction compartment 748 with driver pump suction line 711 as shown in FIGS. 2 and 3.

It is understood that the steps disclosed herein (or parts thereof) may all be performed simultaneously. While the steps were described in such a manner to illustrate the flow of the lube oil through the lube oil system 700, each step is constantly being performed during operation of the lube oil system 700.

The preceding detailed description is merely exemplary in nature and is not intended to limit the invention or the application and uses of the invention. The described embodiments are not limited to use in conjunction with a particular type of gas turbine engine. Hence, although the present disclosure, for convenience of explanation, depicts and describes a particular lube oil system and lube oil tank, it will be appreciated that the lube oil tank in accordance with this disclosure can be implemented in various other configurations, can be used with various other types of lube oil systems, and can be used in other types of machines. Furthermore, there is no intention to be bound by any theory presented in the preceding background or detailed description. It is also understood that the illustrations may include exaggerated dimensions to better illustrate the referenced items shown, and are not consider limiting unless expressly stated as such.

What is claimed is:

1. A gas turbine engine lube oil system comprising:
a first passage having
a first elongated compartment including
a closed end,
a first open end distal to the closed end, and
a plurality of bearing return line connection points;
a second passage having
a second elongated compartment including
a suction end, and
a second open end distal to the suction end; and
wherein the first open end is in flow communication with the second open end.

2. The lube oil system of claim 1, wherein the first elongated compartment is a rectangular tube and the second elongated compartment is a rectangular tube.

3. The lube oil system of claim 1, wherein the first passage is welded to the second passage.

4. The lube oil system of claim 1, wherein the first elongated compartment and the second elongated compartment each have a length longer than a combined length of a compressor section, a combustion section, and a turbine section of the gas turbine engine.

5. The lube oil system of claim 1, wherein the first elongated compartment and the second elongated compartment are parallel to the axis of the gas turbine engine.

6. The lube oil system of claim 5, wherein the first elongated compartment is configured to flow lube oil in a first direction parallel to the axis of the gas turbine engine, and the second elongated compartment is configured to flow lube oil in a second direction parallel to the axis of the gas turbine engine, the second flow direction being in the direction opposite the first flow direction.

7. The lube oil system of claim 1, wherein the first passage includes a first compartment connected to the first open end, the second passage includes a second compartment connected to the second open end, and a flow transfer compartment connected to the first compartment distal to the connection to the first open end and to the second compartment distal to the connection to the second open end.

8. The lube oil system of claim 1, further comprising;
a main driven pump;
a driven pump suction line adjacent to the suction end of the second passage;
a plurality of bearing assemblies in flow communication with the main driven pump;
a plurality of bearing return lines, each bearing return line connected to one of the plurality of bearing assemblies and to the first passage.

9. A gas turbine engine including the lube oil system of claim 1.

10. A gas turbine engine lube oil system comprising:
a first elongated compartment having
a closed end, and
a first open end distal to the closed end;
a second elongated compartment parallel and adjacent to the first elongated compartment, the second elongated compartment having
a suction end adjacent to the closed end, and
a second open end distal to the suction end and adjacent to the first open end; and a sub-divided containment area having
a first compartment in flow communication with the first open end,
a second compartment in flow communication with the second open end, and
a flow transfer compartment in flow communication with the first compartment at a location distal to the first open end and in flow communication with the second compartment at a location distal to the second open end,
wherein bulkheads sub-divide the first compartment, the second compartment, and the flow transfer compartment;
wherein the first elongated compartment and first compartment form a first passage and the second elongated compartment and second compartment form a second passage, and the first passage is configured to connect to a of bearing return lines.

11. The lube oil system of claim 10, wherein the first compartment includes a first side compartment and a first corner compartment, and the second compartment includes a second side compartment and a second corner compartment.

12. The lube oil system of claim 11, wherein the flow transfer compartment is in flow communication with the first corner compartment and in flow communication with the second corner compartment.

13. The lube oil system of claim 12, wherein the first compartment includes a reduction gearbox drain compartment in flow communication with the first side compartment.

14. The lube oil system of claim 10, wherein the first elongated compartment is welded to the second elongated compartment.

15. The lube oil system of claim 10, wherein the first passage and the second passage each have a length longer than the length of the gas turbine engine.

16. A lube oil system of claim 10, further comprising:
a plurality of bearing return lines having
a first bearing return connected to the closed end,
a second bearing return connected to the first elongated compartment,
a third bearing return connected to the first elongated compartment, and
a fourth bearing return connected to the first compartment.

17. A lube oil system of claim 16, further comprising:
a main driven pump;
a driven pump suction line adjacent to the suction end of the second passage;
a plurality of bearing assemblies in flow communication with the main driven pump;
a plurality of bearing return lines, each bearing return line connected to one of the plurality of bearing assemblies and to the first passage.

18. A gas turbine engine including the lube oil system of claim 10.

19. A method for deaerating lube oil in a gas turbine engine lube oil system, the method comprising:
returning lube oil from gas turbine engine bearing assemblies to a first passage of an elongated passage lube oil tank;
flowing the lube oil from bearing return line connection points in the first passage through the first passage to a first flow transfer connection point and away from a closed end of the first passage, the first flow transfer connection point being distal to the closed end of the first passage;
transferring the lube oil from the from the first flow transfer connection point to a second flow transfer connection point of a second passage of the elongated passage lube oil tank by a flow connection means, the second passage being in flow isolation from the first passage except for the flow connection means; and
flowing the lube oil from the second flow connection point to a suction end of the second passage, the second flow connection point being distal to the suction end.

20. The method of claim 19, further comprising pumping the lube oil from the suction end of the second passage.
